(19) United States
(12) Patent Application Publication
(10) Pub. No.: US 2013/0077163 A1
(43) Pub. Date: Mar. 28, 2013

(54) STEREOSCOPIC DISPLAY DEVICE

(71) Applicant: Yamada Shoji, Tokyo (JP)

(72) Inventor: Yamada Shoji, Tokyo (JP)

(73) Assignee: QUASAR TECHNOLOGY INC, Kanagawa-Ken (JP)

(21) Appl. No.: 13/244,192

(22) Filed: Sep. 23, 2011

(51) Int. Cl. G02B 27/24

(52) U.S. Cl. 359/479

(57) ABSTRACT

A stereoscopic display device having a variety of uses is provided, allowing a distance between reflective means and a watcher to be reduced when a single two-dimensional image displayed on image displaying means is reflected by the reflective means to be viewed stereoscopically, so that a two-dimensional image with a small size can also be viewed stereoscopically. The reflective means has the two-dimensional image reflected and has a three-dimensional virtual image displayed.

### FIELD OF THE INVENTION

The present invention relates to a stereoscopic display device in which a two-dimensional image is reflected by a concave mirror, so as to allow an observer to perceive a three-dimensional virtual image.

### BACKGROUND OF THE INVENTION

Heretofore, a device enabling naked-eyes stereoscopic vision by making two images containing a binocular parallax be respectively viewed by one's left eye and right eye has been known as a means for watching stereoscopic images. Methods of stereoscopically viewing two images with one's naked eyes includes a parallel method of viewing a right-side image with the right eye and viewing a left-side image with the left eye, and a crossing method of viewing a left-side image with the right eye and viewing a right-side image with the left eye.

However, it is required to prepare a pair of images containing a binocular parallax, no mater which one of the stereoscopic viewing methods is used. It is difficult to view an existing single image stereoscopically.

On the other hand, for example, a technique is disclosed in patent document 1 (Japan patent registration No. 4222627) in which an apparatus for stereoscopically viewing images is provided with a pair of planar mirrors and disposed in front of a television, wherein a two-dimensional image from the television is reflected by one of the planar mirrors and shown in the other planar mirror, to allow a watcher to view the image shown in the other planar mirror as a three-dimensional virtual image.

In other words, due to the convergence angle when the watcher gazing the television through the apparatus for stereoscopically viewing images, the wideness of the field of view of the watcher with respect to the other planar mirror is narrow. Because the wideness of the field of view is close to 0, the watcher can only look the image shown in the other planar mirror with a single eye, thereby enabling the watcher to have a stereoscopic vision.

Meanwhile, for example, a technique is disclosed in patent document 2 (Japan patent registration No. 4365435) in which a Fresnel lens is disposed in front of a display means such as a screen of a television, a monitor of a personal computer or the like, to allow two eyes of a watcher to view images provided with a pseudo-parallax caused by refraction of the Fresnel lens, thereby allowing the watcher to perceive a three-dimensional virtual image having a depth.

### PRIOR TECHNICAL DOCUMENTS

### Patent Documents

Patent document 1: Japan patent registration No. 4222627

Patent document 2: Japan patent registration No. 4365435

### SUMMARY OF THE INVENTION

### Problems to be Solved by the Invention

However, according to the technique disclosed in the above-described patent document 1, in order to increase the difference between the inter-pupil wideness of a watcher and the wideness of the field of view of the other mirror, it is required to ensure a considerable distance between the watcher and the other mirror (60˜70 [cm] according to the same patent document). Therefore, there is a problem of viewing an image roughly having a B6 size, which is displayed as a photograph, a digital photo-frame or the like, from a too long distance.

Therefore, the apparatus for stereoscopically viewing images disclosed in the above-described patent document is limited to uses of viewing television images having large inch sizes or the like.

Moreover, according to the technique described in the patent document 2, bands having a concentric circle shape are adversely contained in a three-dimensional virtual image perceived by a watcher, because a Fresnel lens is formed with a cross-section having a saw shape.

Therefore, a purpose of the present invention is to provide a stereoscopic display device having a variety of uses, in which a distance between a reflective means and a watcher can be reduced when a single two-dimensional image displayed on a image displaying means is reflected by the reflective means to be viewed stereoscopically, so that a two-dimensional image with a small size can also be viewed stereoscopically.

### Means for Solving the Problems

For attaining the above-described purposes, the first one of the present inventions is a stereoscopic display device including an image display means displaying a single two-dimensional image, a reflective means having said two-dimensional image reflected and having a three-dimensional virtual image displayed, and a supporting means supporting said reflective means, wherein said reflective means is composed of at least one concave mirror.

According to the above-described configuration, a single two-dimensional image displayed on the image display means is reflected by the reflective means composed of at least one concave mirror, thereby allowing a three-dimensional virtual image to be displayed. Therefore, it is possible to reduce a separation distance between the reflective means and a watcher, and hence a two-dimensional image with a small size can also be viewed stereoscopically, thereby enabling a variety of uses.

The second one of the present inventions is the stereoscopic display device according to the first invention, wherein said concave mirror is any one of concave planar mirror, concave conical mirror, concave curved mirror and concave parabolic mirror.

According the above-described invention, the most appropriate concave mirror may be selected corresponding to the type of three-dimensional image, the required distortion of image or the cost, by using any one of concave planar mirror, concave conical mirror, concave curved mirror and concave parabolic mirror as the concave mirror.

The third one of the present inventions is the stereoscopic display device according to the first invention, wherein said concave mirror is a concave conical mirror having planes arranged in an up-and-down direction while having said two-dimensional image from said image display means reflected upwardly with respect to said image display means.

According the above-described invention, because a concave conical mirror is used as the concave mirror in which the planes of the concave conical mirror are arranged in the up-and-down direction, and the two-dimensional image from the image display means is reflected upwardly with respect to said image display means, the watcher can easily perceive a three-dimensional virtual image which is reflected by the concave conical mirror and provided with a reduced distortion from an upper side of the image display means.

The fourth one of the present inventions is the stereoscopic display device according to the first invention or the second invention, wherein said reflective means is composed of a first reflective mirror reflecting said two-dimensional image from said image display means and a second reflective mirror reflecting the reflected image from the first reflective mirror, wherein said first reflective mirror is a planar mirror, and said second reflective mirror is said concave mirror.

According the above-described invention, because the reflective means is configured such that the two-dimensional image from the image display means is reflected by a planar mirror which is the first reflective mirror, and the reflected image from the first reflective mirror is then reflected by a concave mirror which is the second reflective mirror, to allow the watcher to perceive a three-dimensional virtual image, the watcher can view a normal image.

The fifth one of the present inventions is the stereoscopic display device according to the first invention or the second invention, wherein said reflective means is composed of a first reflective mirror reflecting said two-dimensional image from said image display means and a second reflective mirror reflecting the reflected image from the first reflective mirror, wherein said first reflective mirror is a convex mirror or a convex mirror, and said second reflective mirror is said concave mirror or a convex mirror.

According the above-described invention, the reflective means is configured such that the two-dimensional image from the image display means is reflected by a convex mirror or a concave mirror which is the first reflective mirror, and the reflected image from the first reflective mirror is then reflected by a concave mirror or a convex mirror which is the second reflective mirror, to allow the watcher to perceive a three-dimensional virtual image (normal image) due to the refraction of the concave mirror. The three-dimensional virtual image perceived by the watcher is provided with a reduced distortion due to the reflection of the convex mirror.

The sixth one of the present inventions is the stereoscopic display device according to the first invention, wherein said reflective means is composed of a first reflective mirror reflecting said two-dimensional image from said image display means and a second reflective mirror reflecting the reflected image from the first reflective mirror, wherein said first reflective mirror is a concave planar mirror having planes arranged in an up-and-down direction, and said second reflective mirror is a concave planar mirror having planes arranged in a left-and-right direction.

According the above-described invention, the reflective means is configured such that the two-dimensional image from the image display means is reflected by a concave planar mirror having up-and-down planar surfaces which is the first reflective mirror, and the reflected image from the first reflective mirror is then reflected by a concave planar mirror having left-and-right planar surfaces which is the second reflective mirror, to allow the watcher to perceive a three-dimensional virtual image. The three-dimensional virtual image perceived by the watcher is provided with reduced distortions both in a up-and-down direction and a left-and-right direction, due to the combination of the concave planar mirror having up-and-down planes and the concave planar mirror having left-and-right planes.

The seventh one of the present inventions is the stereoscopic display device according to the fourth invention to the sixth invention, wherein said supporting means is a frame for fixing the first reflective mirror and the second reflective mirror, and a fixing part fixed onto said image display means is provided in said frame.

According the above-described invention, because the first reflective mirror and the second reflective mirror are fixed and integrated by the frame which is the supporting means, and the fixing part provided in the frame is fixed onto the image display means, the first reflective mirror and the second reflective mirror can be easily installed onto the image display means, therefore providing a good operability.

The eighth one of the present inventions is the stereoscopic display device according to the first invention to the seventh invention, wherein said image display means is any one of photograph, book, electronic book, mobile phone, digital photo frame, portable image display device, digital camera, flat panel computer, monitor for personal computer and television receiver.

According the above-described invention, because a single two-dimensional image is reflected by the reflective means so as to allow a three-dimensional virtual image to be perceived, the two-dimensional image may be a stationary image or a moving image. Furthermore, it is not required to prepare a pair of two-dimensional images having a binocular parallax therebetween. It is possible to use an image shown on an ordinary photograph, book, electronic book, mobile phone, digital photo frame, portable image display device, digital camera, flat panel computer, monitor for personal computer or television receiver as the display object, and therefore a high versatility can be attained.

The ninth one of the present inventions is the stereoscopic display device according to the first invention to the seventh invention, wherein a mirror image processing means for performing a mirror image processing of said two-dimensional image so as to allow the processed image to be displayed is provided in said image display means.

According the above-described invention, the mirror image processing is performed on the two-dimensional image by the mirror image processing means and the processed image is displayed, thereby allowing the watcher to perceive a three-dimensional virtual image which is a normal image

### Effects of the Invention

According to the present invention, a single two-dimensional image displayed on the image display means is reflected by the reflective means composed of at least one concave mirror, thereby allowing a three-dimensional virtual image to be displayed. Therefore, it is possible to reduce a separation distance between the reflective means and a watcher, and hence a two-dimensional image with a small size can also be viewed stereoscopically, thereby enabling a variety of uses.

### DESCRIPTIONS OF THE DRAWING

FIG. 1 is a perspective view showing a stereoscopic display device according to the first embodiment of the present invention.

FIG. 2 is a side view showing the stereoscopic display device according to the first embodiment of the present invention.

FIG. 3 are views showing a concave conical mirror according to the first embodiment of the present invention, wherein (a) is a front view, (b) is a plan view, and (c) is a bottom view.

FIG. 4 is an illustrative drawing showing an image being viewed by one's left eye according to the first embodiment of the present invention.

FIG. 5 is an illustrative drawing showing an image being viewed by one's right eye according to the first embodiment of the present invention.

FIG. 6 is an illustrative drawing showing a status in which a three-dimensional virtual image is perceived by one's left and right eyes according to the first embodiment of the present invention.

FIG. 7 is a block diagram shown a simplified configuration of a stereoscopic display device according to the first embodiment of the present invention.

FIG. 8 is a perspective view showing a status in which a stereoscopic display device is installed on a personal computer according to the second embodiment of the present invention.

FIG. 9 is a perspective view showing a status in which a stereoscopic display device is installed on a personal computer according to the third embodiment of the present invention.

FIG. 10 is a perspective view showing a status in which a stereoscopic display device is installed on a personal computer according to the fourth embodiment of the present invention.

### EMBODIMENTS

An embodiment of the present invention will be explained with reference to the drawings.

### First Embodiment

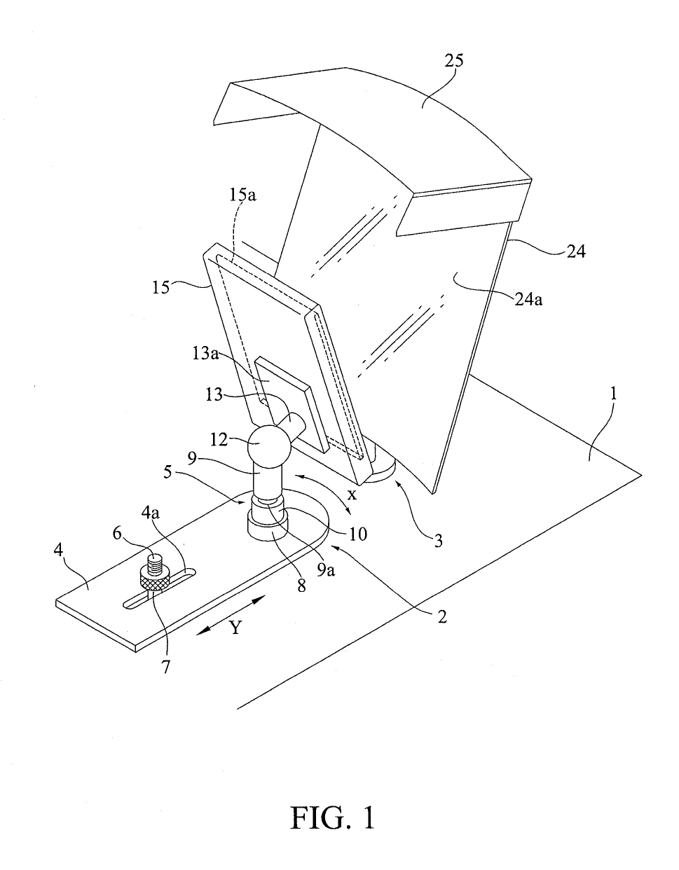

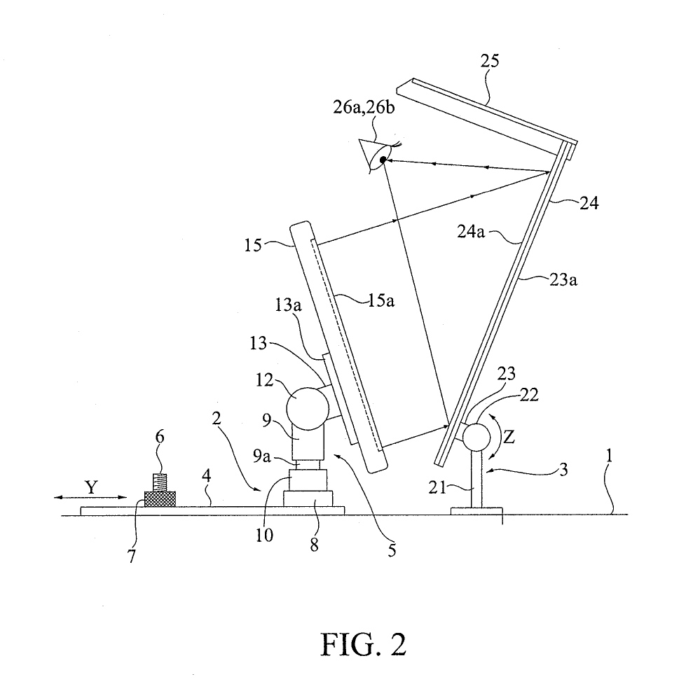

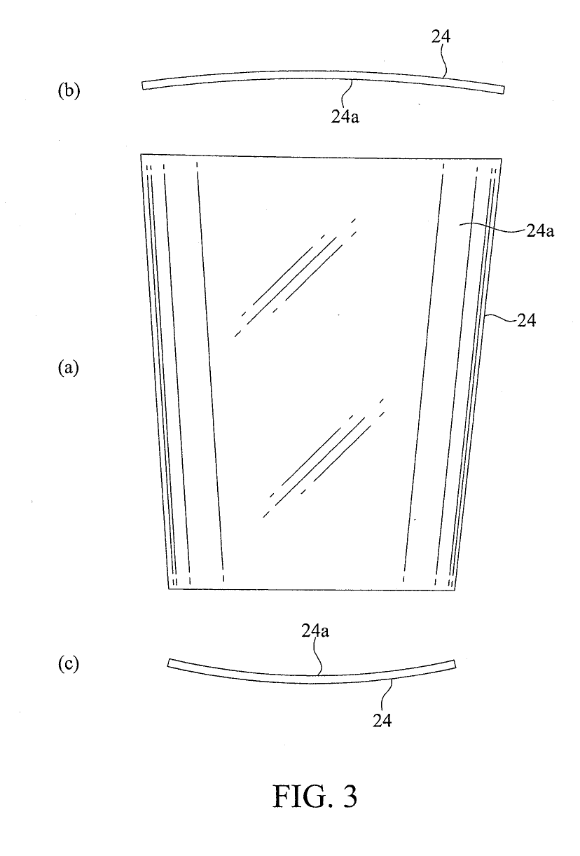

The first embodiment of the present invention is shown in FIGS. 1-6. The reference number 1 in FIG. 1 and FIG. 2 represents a table of a stereoscopic display device. A display device stand 2 and a mirror stand 3 are vertically arranged on this table 1 such that the display device stand 2 and the mirror stand 3 are opposed to each other.

The display device stand 2 has a stand base 4. The stand base 4 is formed with an elongated boat shape, and a stand part 5 is vertically arranged on a bow-side end which is one end of the stand base 4 in a longitudinal direction, while an elongated hole 4a extending toward a stern-side end which is the other end of the stand base 4 is provided in back of the stand part 5. A screw 6 is slidably inserted through the elongated hole 4a and vertically arranged with respect to the table 1, while a finger nut 7 is screw-engaged with the screw 6. When the finger nut 7 is loosened, the stand base 4 of the display device stand 2 can be moved in the longitudinal direction (the direction indicated by the arrow Y) as well as be rotated about the screw 6 in a direction indicated by the arrow X on the table 1 with the stand base 4 being supported by the screw 6 slidably inserted through the elongated hole 4a.

Moreover, the stand part 5 has a stand holder 8 fixed on the table 1 and a stand body 9. The stand holder 8 is formed with a cylinder shape having a guiding hole (not shown) for insertion of a stand rod 9a protruding from a lower end of the stand body 9. A stand nut 10 is provided on an upper part of the stand holder 8.

The stand nut 10 is used for securing and fixing the stand rod 9a, which is inserted into the guiding hole of the stand holder 8, on the stand holder 8, and the height of the stand body 9 can be adjusted by moving the stand rod 9a in an up-and-down direction with respect to the guiding hole.

Moreover, an arm 13 is connected to an upper part of the stand body 9 via a ball joint mechanism 12. The ball joint mechanism 12 is provided for supporting the arm 13 such that the arm 13 can swing in every direction freely, so that the arm 13 can be fixed at a desired position by a fastening member which is not shown.

Moreover, an installation part 13a is fixed onto the arm 13, and a portable image display device 15 (it will be simple called “image display device” below) which is an image display means is fixed on the installation part 13a such that a display 15a thereof is orientated to face toward a front direction. The image display device may be exemplified by electronic book, mobile phone, digital photo frame, portable game machine, PDA (Personal Digital Assistant), PND (Personal Navigation Device) and the like. Furthermore, the image display means is not limited to these image display devices 15, but can be any kind of device which has a display 15a, such as digital camera. For a machine having a display (monitor) 15a provided on a back side thereof, such as digital camera, the machine is such installed that the front surface of the machine is orientated to face toward the installation part 13a side.

Moreover, a means (fixing means) for fixing the image display device 15 on the installation part 13 may be exemplified by a two-side adhesive tape and a surface fastener, as well as a fixing structure in which a hook is formed on the installation part 13 and the hook is engaged to a hook groove formed on the image display device 15.

Meanwhile, a stand body 21 of the mirror stand 3 is vertically arranged on the table 1. An arm 23 is provided above the stand body 21 with an elevation angle adjusting part 22 interposed therebetween, and a mirror installation part 23a is fixed onto a front end of the arm 23. A concave conical mirror 24 constituting a reflective means, which is an example of concave mirror, is fixed on the mirror installation part 23a, and a reflective surface 24a thereof is orientated to face toward the display 15a side of the image display device 15. Moreover, a hood 25 is installed on an upper part of the concave conical mirror 24.

Moreover, as shown by the arrow Z in FIG. 2, the elevation angle adjusting part 22 is provided for adjusting the elevation angle of the concave conical mirror 24, and is positioned and fixed upon a fastening member, which is not shown, being tightened. As shown in FIG. 3, the concave conical mirror 24 is provided with a reflective surface 24a which is formed with a shape constituting a part of an inner circumferential surface of a conical shape with planes being disposed in an up-and-down direction, wherein the curvature in the lower side thereof is set to be bigger than the curvature in the upper side thereof. In other words, the radius of curvature in the lower side is set to be smaller than the radius of curvature in the upper side. A single two-dimensional image displayed on the display 15a of the image display device 15 is reflected in an obliquely upward direction by the reflective surface 24a of the concave conical mirror 24, so that the reflected image is viewed with a predetermined parallax provided between the left and right eyes 26a, 26b of a watcher due to the refraction occurring in the reflection. As a result, the watcher can perceive a three-dimensional virtual image by viewing the image reflected from the concave conical mirror 24 stereoscopically with his/her naked eyes.

Next, the action of using the stereoscopic display device configured as above to produce two images (virtual images) having a parallax from a single two-dimensional image and viewing the produced images stereoscopically with one's naked eyes will be explained as follows.

First, the image display device 15 is fixed onto the installation part 13a of the stand part 5 via a fixing means according to a predetermined fashion, and the display 15a is orientated to face toward the concave conical mirror 24 side.

Next, the position and the tilting angle of the display 15a of the image display device 15 which has been fixed onto the installation part 13a, and the elevation angle of the reflective surface 24a of the concave conical mirror 24 are adjusted. As shown in FIG. 2, a single two-dimensional image which is displayed on the display 15a of the image display device 15 is reflected by the reflective surface 24a of the concave conical mirror 24, so that images provided with a binocular parallax caused by the refraction occurring in the reflection are viewed by the left and right eyes 26a, 26b of a watcher, so as to be perceived as a three-dimensional virtual image. Therefore, the adjusting operation is performed while the watcher views the image reflected by the reflective surface 24a of the concave conical mirror 24.

In other words, the finger nut 7 is loosened, and the stand base 4 is moved forward or backward, thereby adjusting the distance between the concave conical mirror 24 and the display 15a. After the distance is adjusted to a predetermined distance, the finger nut 7 is tightened and fixed again. Moreover, the stand nut 10 of the stand part 5 is loosened, and the stand rod 9a protruding from the lower part of the stand body 9 is moved upward or downward with respect to the stand holder 8, so as to adjust the height of the display 15a. After the height is adjusted to a predetermined height, the stand nut 10 is tightened again to fix the height. Furthermore, the fastening member for fixing the ball joint mechanism 12 is loosened, and the arm 13 is swung about the stand body 9 in an up direction, a down direction, a left direction or a right direction, so as to adjust the orientation of the display 15a. After the orientation is adjusted to a predetermined orientation, the fastening member is tightened and fixed again.

Meanwhile, a fastening member (not shown) for fastening the elevation angle adjusting part 22 provided on the upper part of the stand body 21 is loosened, so as to adjust the elevation angle of the reflective surface 24a of the concave conical mirror 24. After the elevation angle is adjusted to a predetermined elevation angle, the fastening member is tightened and fixed again.

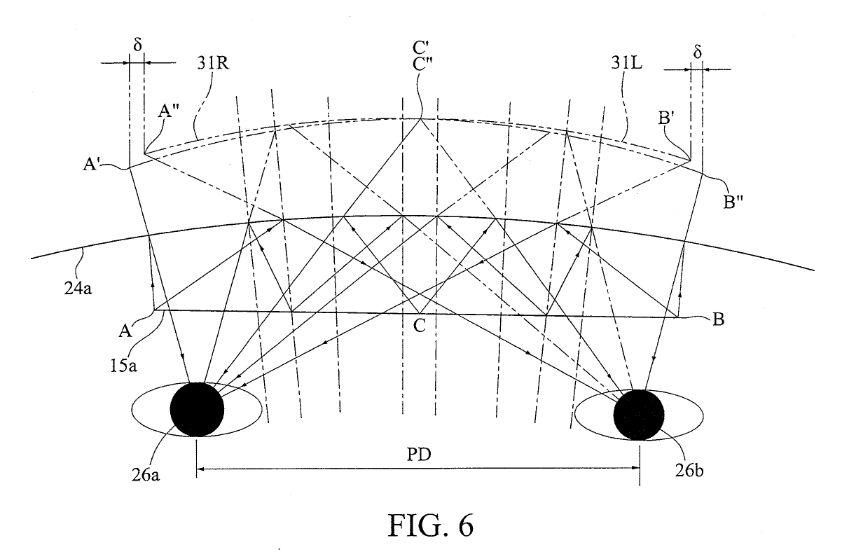

Then, in a state in which the position relation between the display 15a of the image display device 15 and the reflective surface 24a of the concave conical mirror 24 has been adjusted to a predetermined position relation, as shown in FIG. 2, the watcher views the reflective surface 24a of the concave conical mirror 24 with his/her left and right eyes 26a, 26b. Incidentally, as shown in FIG. 6, there is an inter-pupil distance PD (about 6˜7 cm) between one's left and right eyes 26a, 26b, and a depth information may be recognized due to the difference of images projected on one's left and right eyes 26a, 26b, which is then perceived as a three-dimensional virtual image.

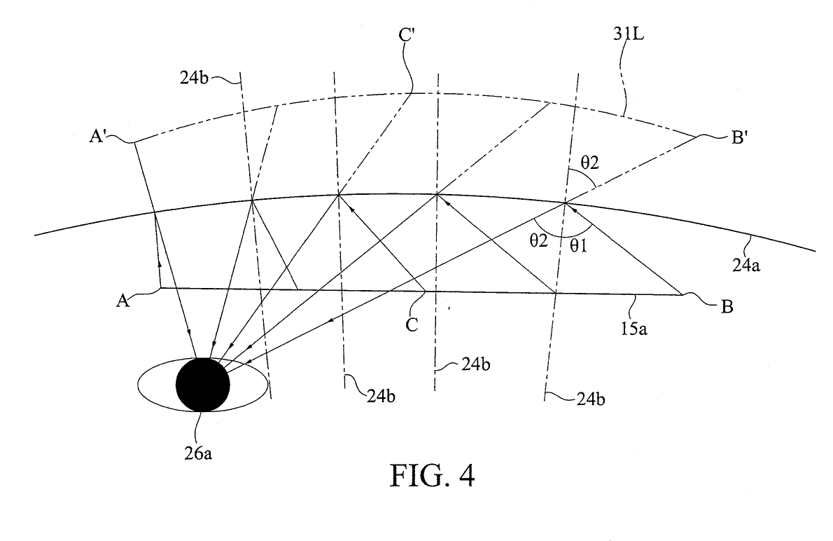

As shown in FIG. 4, a single two-dimensional image displayed on the display 15a is reflected on the reflective surface 24a of the concave conical mirror 24. When the reflected image is viewed by one's left eye 26a, the imaged projected on the reflective surface 24a is reflected with an angle θ2 (reflective angle) which is symmetrical to an incident angle θ1 with respect to a normal line extending from a center of curvature of the concave conical mirror 24. Moreover, if the left eye 26a is closer to the reflective surface 24a side than the focus point of the concave conical mirror 24, a left virtual image 31L may be viewed by the left eye 26a. It is to be appreciated that reference numbers A′, B′ and C′ of the left virtual image 31L respectively represent positions corresponding to A, B and C of the display 15a, and the left virtual image 31L is an mirror image. The reflective angle θ2 is an acute angle at a side near to the left eye 26a, and gradually becomes bigger and bigger to become an obtuse angle as the distance from the left eye 26a becomes larger and larger.

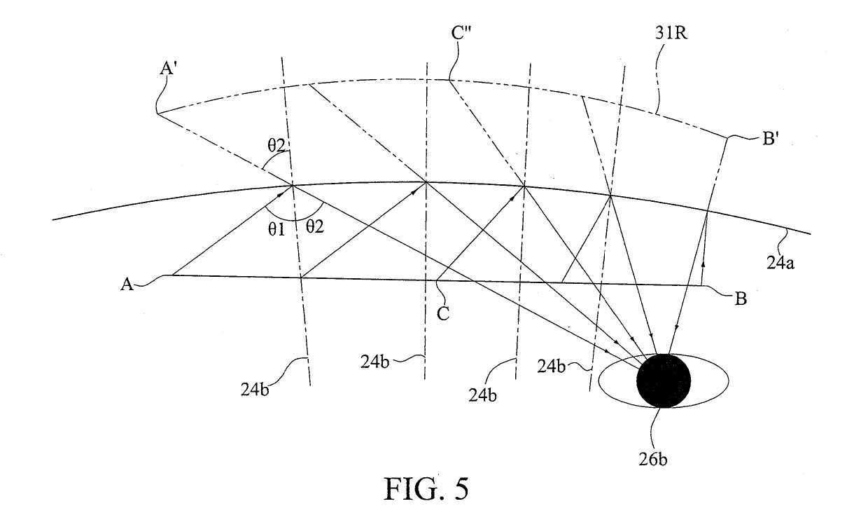

Meanwhile, as shown in FIG. 5, a reflected image reflected by the reflective surface 24a of the concave conical mirror 24 is viewed by one's right eye 26b as a right virtual image 31L, because the right eye 26b is closer to the reflective surface 24a than the focus point of the concave conical mirror 24. Moreover, the reflective angle θ2 is an acute angle at a side near to the right eye 26b, and gradually becomes bigger and bigger to become an obtuse angle as the distance away from the right eye 26b becomes larger and larger. It is to be appreciated that reference numbers A″, B″ and C″ of the right virtual image 31R respectively represent positions corresponding to A, B and C of the display 15a, and the right virtual image 31L is an mirror image. The reflective angle θ2 is an acute angle at a side near to the left eye 26a, and gradually becomes bigger and bigger to become an obtuse angle as the distance from the left eye 26a becomes larger and larger.

As a result, as shown in FIG. 6, the left virtual image 31L and the right virtual image 31 R shifting by a distance δ from each other in a left-and-right direction are viewed by the left eye 26a and the right eye 26b respectively. Because of this shifting distance δ, an approximate parallax is formed and a three-dimensional virtual image, in other words a depth is perceived by the watcher.

Moreover, in the present embodiment, the concave conical mirror 24 is used as a reflective means, wherein planes thereof are arranged in the up-and-down direction and the curvature in the lower side is increased, and the curvature in the upper side is decreased. Therefore, as shown in FIG. 2, when the reflected image (virtual image) from the reflective surface 24a is viewed from an obliquely upward direction, the distortion caused by the difference between a distance from the lower part of the reflective surface 24a to one's left and right eyes 26a, 26b and a distance from the upper part of the reflective surface 24a to the one's left and right eyes 26a, 26b can be mitigated due to the difference between the curvature in the upper side and the curvature in the lower side of the concave conical mirror 24, and a good three-dimensional virtual image can be perceived.

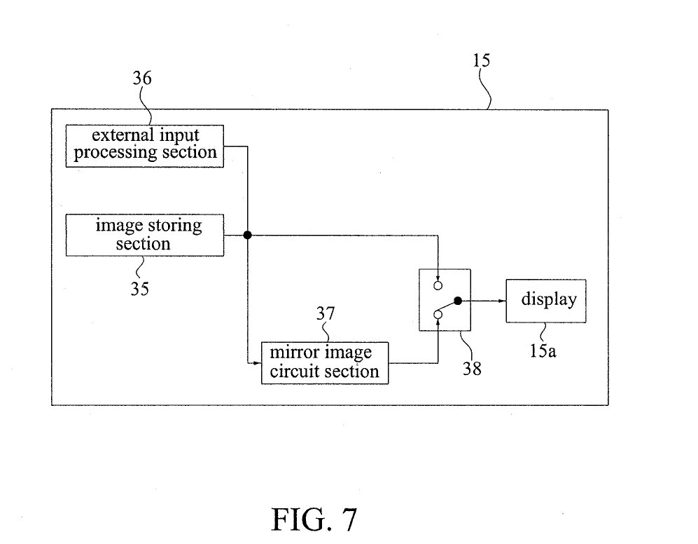

By the way, as shown in FIG. 7, the image display device 15 according to the present embodiment includes a mirror image circuit section 37 functioning as a mirror image processing means for performing a mirror image processing on an image (normal image) stored in an image storing section 35 and a pointer (cursor) outputted from an external input processing section 36, and a display selection circuit section 38 functioning as a display selecting means for selecting either the normal image from the image storing section 35 or the mirror image from the mirror image circuit section 37 as the image to be displayed on the display 15a, so that the image stored in the image storing section 35 may be displayed on the display 15 as either a normal image thereof or a mirror image thereof, and an operation of a mouse and the like may also be performed on the mirror image.

The switching operation of the display selection circuit section 38 is performed by an operator using an external inputting means, such as a mouse (not shown), an operating button or the like, connected to the image display device 15, or using the display 15a as an external inputting means in a case that the display 15a functions as a touch panel.

When the image storing section 35 and the external input processing section 36 are connected to the display 15a via the display selecting circuit section 38 due to the operation of the operator, the normal image from the image storing section 35 and the pointer (cursor) outputted from the external input processing section 36 are displayed on the display 15 as what they are. On the other hand, when the external input processing section 36 and the mirror image circuit section 37 are connected to the display 15a via the display selecting circuit section 38, the normal image from the image storing section 35 and the pointer (cursor) outputted from the external input processing section 36 are changed to mirror images by the mirror image circuit section 37 so as to be displayed on the display 15a.

Therefore, when a watcher intends to stereoscopically view an imaged displayed on the display 15a of the image display device 15 with his/her naked eyes by using the concave conical mirror 24, the mirror image circuit section 35 and the extern input processing section 36 are adapted to be connected to the display 15a via the display selection circuit section 37, to allow a mirror image to be displayed on the display 15a. As a result, the watcher can perceive the image outputted from the mirror image circuit section 35 as a three-dimensional virtual image of the normal image. Furthermore, because the pointer (cursor) is displayed on the display 15a with its normal image status, an operation direction of an external inputting means such as mouse or the like operated by the watcher is consistent with a moving direction of the pointer (cursor) displayed on the display 15a, and therefore a good operability can be obtained.

### Second Embodiment

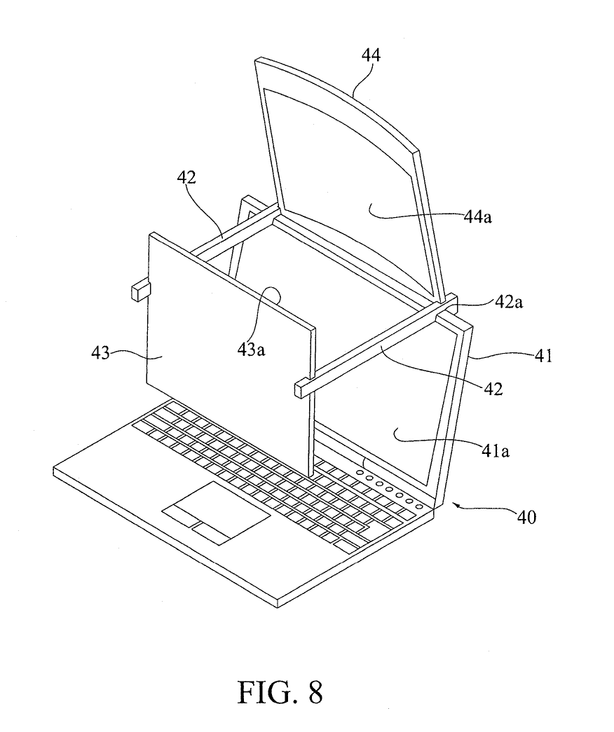

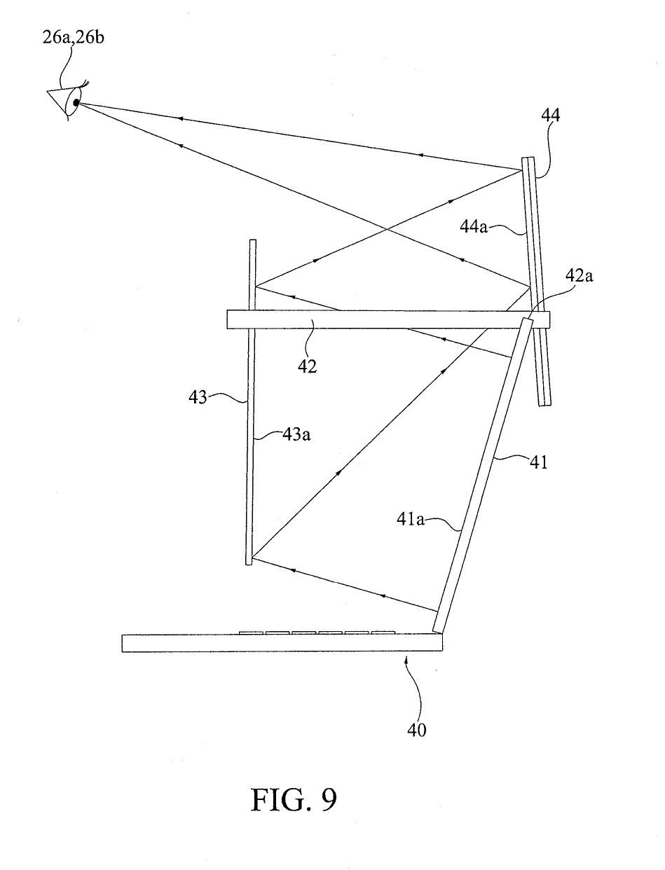

The second embodiment of the present invention is shown in FIG. 8 and FIG. 9. In the above-explained first embodiment, a case has been explained in which the image display means is exemplified by the portable image display device 15. In the present embodiment, an example will now be explained in which a stereoscopic display device is installed on a display surface 41 a of a monitor 41 provided in a notebook type personal computer (hereinafter, it will be called “notebook”) 40.

As shown in FIG. 8, a stereoscopic display device according to the present embodiment has a pair of left and right frames 42, and a first reflective mirror 43 and a second reflective mirror 44 which are an example of reflective means are fastened at the front end side and the back end side of those two frames 42 respectively.

The first reflective mirror 43 is a planar mirror, and both ends of an upper side thereof are fixed onto the pair of frames 42, such that the first reflective mirror 43 is opposed to the monitor 41 of the notebook 40. Moreover, the second reflective mirror 44 is a concave planar mirror formed with a shape in which the reflective surface 44a constitutes a part of an inner circumferential surface of a cylinder shape and planes thereof are arranged in an up-and-down direction. Both ends of a lower side of the second reflective mirror 44 are fixed onto the frames 42. Moreover, installation grooves 42a for engagement with an upper part of an outer frame of the monitor 41 are formed in an intermediate part of the frames 42, and the frames 42 are detachably positioned and fixed by clips which are not shown.

As shown in FIG. 9, the installation grooves 42a of the frames 42 are mounted on an upper part of the outer frame of the monitor 41, and the frames 42 are fixed by the clips. In such a state, the first reflective mirror 43 which is a planar mirror is opposed to the monitor 41, and an image from the display surface 41 a of the monitor 41 is incident to the reflective surface 43a and then reflected by the reflective surface 44a of the second reflective mirror 44.

According to the present embodiment, because the image displayed on the display surface 41a of the monitor 41 is reflected by each reflective surfaces 43a, 44a of the first and second reflective mirrors 43, 44, the left and right virtual images 31L, 31R (referred to FIG. 6) produced by the refraction of the reflective surface 44a of the second reflective mirror 44 and viewed by the left and right eyes 26a, 26b of a watcher is a normal image which is the same as the image displayed on the display surface 41a of the monitor 41, whereby the watcher can perceive a three-dimensional virtual image from the left and right virtual images 31L, 31R which are displayed as normal images.

Moreover, because the second reflective mirror 44 is at a position relatively closer to the left and right eyes 26a, 26b of the watcher in a front side, the distortion in the up-and-down direction is less. Therefore, it is not required to use a concave conical mirror 24, like the first embodiment. The distortion in the left-and-right direction can be reduced by using a concave planar mirror.

Additionally, a concave curved mirror may be used as the second reflective mirror 44 of the present embodiment, which is provided with a reflective surface 44a formed as a curved surface having a relatively larger curvature. Moreover, the reflective surface 44a may be a spherical surface. Alternatively, the second reflective mirror 44 may be a concave paraboloid mirror having a reflective surface 44a formed with a shape constituting a part of an inner circumferential surface of a rotation parabolic shape. In this case, the rotation axis of a parabolic cross section is directed in an up-and-down direction, and a curved surface with a smaller curvature is arranged in a lower side.

### Third Embodiment

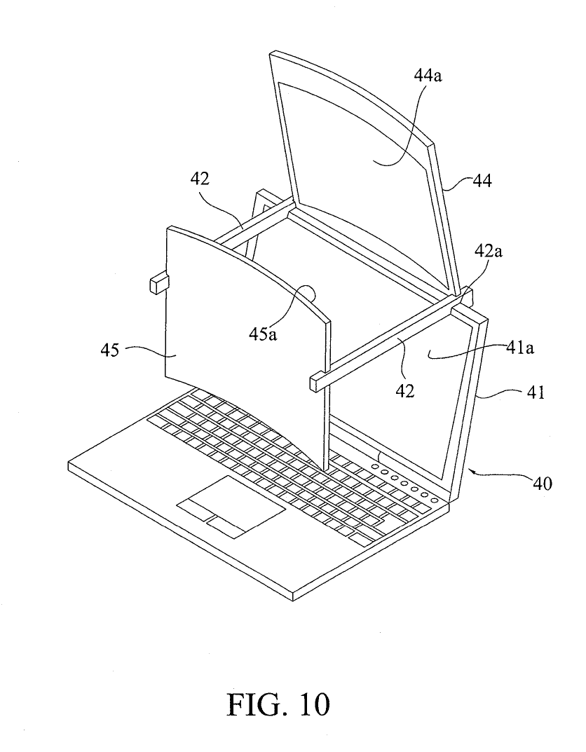

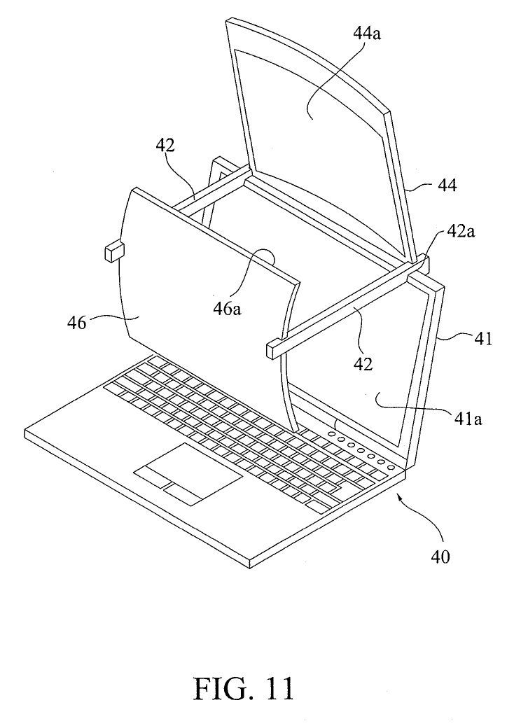

The third embodiment of the present invention is shown in FIG. 10. In the above-explained second embodiment, a planer mirror is used as the first reflective mirror 43. However, in the present embodiment, a convex planar mirror is used as the first reflective mirror 45, which is formed with a shape in which the reflective surface 45a constitutes a part of an outer circumferential surface of a cylinder shape, and planes thereof are arranged in an up-and-down direction.

In a case in which a shrinking distortion is present in a left-and-right direction in the left and right virtual images 31L, 31R viewed by the left and right eyes 26a, 26b of the watcher, by using a convex planer mirror having planes arranged in the up-and-down direction as the first reflective mirror 45, this distortion can be reduced by the refraction occurred at the time when the image is reflected by the reflective surface 45a. Alternatively, in this case, a concave planar mirror may be used as the first reflective mirror 45, while a convex planar mirror may be used as the second reflective mirror 44.

### Fourth Embodiment

The fourth embodiment is shown in FIG. 11. In the above-explained third embodiment, a convex planer mirror having planes arranged in the up-and-down direction is used as the first reflective mirror 45. However, in the present embodiment, a concave planar mirror having planes arranged in a left-and-right direction is used as a first reflective mirror 46.

In a case in which a stretching distortion is present in an up-and-down direction in the left and right virtual images 31L, 31R viewed by a watcher's left and right eyes 26a, 26b, by using a concave planer mirror having planes arranged in the left-and-right direction as the first reflective mirror 46, this distortion can be reduced.

The present invention is not limited to the above-described embodiments. For example, in a case in which a stretching distortion is present in a left-and-right direction in the left and right virtual images 31L, 31R viewed by the left and right eyes 26a, 26b of a watcher, by using a concave planer mirror having planes arranged in a up-and-down direction as the first reflective mirror 45 shown in the third embodiment, the distortion can be reduced. Moreover, in a case in which a stretching distortion is present in an up-and-down direction in the left and right virtual images 31L, 31R viewed by the left and right eyes 26a, 26b of a watcher, by using a convex planer mirror having planes arranged in a left-and-right direction as the first reflective mirror 46 shown in the fourth embodiment, this distortion can be reduced.

1. A stereoscopic display device including:
an image display means displaying a single two-dimensional image;
a reflective means having said two-dimensional image reflected and having a three-dimensional virtual image displayed; and
a supporting means supporting said reflective means;
wherein said reflective means is composed of at least one concave mirror.

2. The stereoscopic display device according to claim 1, wherein said concave mirror is any one of concave planar mirror, concave conical mirror, concave curved mirror and concave parabolic mirror.

3. The stereoscopic display device according to claim 1, wherein said concave mirror is a concave conical mirror having planes arranged in an up-and-down direction, while having said two-dimensional image from said image display means reflected upwardly with respect to said image display means.

4. The stereoscopic display device according to claim 1 or 2, wherein said reflective means is composed of a first reflective mirror reflecting said two-dimensional image from said image display means and a second reflective mirror reflecting the reflected image from the first reflective mirror,
said first reflective mirror is a planar mirror,
said second reflective mirror is said concave mirror.

5. The stereoscopic display device according to claim 1 or 2, wherein said reflective means is composed of a first reflective mirror reflecting said two-dimensional image from said image display means and a second reflective mirror reflecting the reflected image from the first reflective mirror,
said first reflective mirror is a convex mirror,
said second reflective mirror is said concave mirror.

6. The stereoscopic display device according to claim 1, wherein said reflective means is composed of a first reflective mirror reflecting said two-dimensional image from said image display means and a second reflective mirror reflecting the reflected image from the first reflective mirror,
said first reflective mirror is a concave planar mirror having planes arranged in an up-and-down direction,
said second reflective mirror is a concave planar mirror having planes arranged in a left-and-right direction.

7. The stereoscopic display device according to claim 4, wherein said supporting means is a frame for fixing the first reflective mirror and the second reflective mirror;
a fixing part fixed onto said image display means is provided in said frame.

8. The stereoscopic display device according to claim 5, wherein said supporting means is a frame for fixing the first reflective mirror and the second reflective mirror;
a fixing part fixed onto said image display means is provided in said frame.

9. The stereoscopic display device according to claim 6, wherein said supporting means is a frame for fixing the first reflective mirror and the second reflective mirror;
a fixing part fixed onto said image display means is provided in said frame.

10. The stereoscopic display device according to claim 1, wherein said image display means is any one of photograph, book, electronic book, mobile phone, digital photo frame, portable image display device, digital camera, flat panel computer, monitor for personal computer and television receiver.

11. The stereoscopic display device according to claim 1, wherein a mirror image processing means for performing a mirror image processing of said two-dimensional image so as to allow the processed image to be displayed is provided in said image display means.
